(19) United States
(12) Patent Application Publication
(10) Pub. No.: US 2012/0296780 A1
(43) Pub. Date: Nov. 22, 2012

(54) SYSTEMS AND METHODS FOR EXCHANGING PRODUCT INFORMATION

(75) Inventor: Curtis J. McEntirc, Salt Lake City, UT (US)

(73) Assignee: Mazree, Salt Lake City, UT (US)

(21) Appl. No.: 13/473,145

(22) Filed: May 16, 2012

Related U.S. Application Data
(60) Provisional application No. 61/486,684, filed on May 16, 2011.

(51) Int. Cl. G06Q 30/00

(52) U.S. Cl. 705/27.2; 705/26.1

(57) ABSTRACT

Systems and methods for exchanging item information between business entities, in a social network, are disclosed. A profile generator can receive information about a business entity and use the information to generate a business profile. The business profiles can be associated via user initiated connections into a social network. A request generator can receive item detail information and/or questions from a requester to generate an item information request. The request may be sent to one or more request targets. A request target can view and respond to requests via a user interface and/or the business profile. A response generator can receive information from a responder to generate a response to an item information request and send the response to the requester. A requester can view responses and notify responders of the requester's selection of the responder for a transaction. A notification engine can notify users of requests and responses.

### CROSS-REFERENCE TO RELATED APPLICATIONS

This application claims the benefit under 35 U.S.C. §119(e) of U.S. Provisional Patent Application No. 61/486,684, entitled “ SYSTEMS AND METHODS FOR EXCHANGING PRODUCT INFORMATION,” filed May 16, 2011, which is hereby incorporated herein by reference in its entirety.

### COPYRIGHT NOTICE

© 2011 Mazree. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure relates to systems and methods for exchanging information about commercial entities to facilitate commercial transactions, and more particularly to systems and methods for requesting and communicating product and/or service information of a business entity.

### BRIEF DESCRIPTION OF THE DRAWINGS

FIG. 1 is a graphical depiction of a user interface displaying a business profile, according to one embodiment.

FIG. 2 is a graphical depiction of a user interface receiving item information of a business entity, according to one embodiment.

FIG. 3 is a graphical depiction of a user interface displaying search results of a search to identify request targets, according to one embodiment.

FIG. 4 is a graphical depiction of a user interface to receive input specifying general information for an item information request, according to one embodiment.

FIG. 5 is a graphical depiction of a user interface to receive input specifying terms for an item information request, according to one embodiment.

FIG. 6 is a graphical depiction of a user interface to receive input specifying item details for an item information request, according to one embodiment.

FIG. 7 is a graphical depiction of a user interface to receive input specifying questions for an item information request, according to another embodiment.

FIG. 8 is a graphical depiction of a user interface to receive input specifying one or more request targets, according to one embodiment.

FIG. 9 is a graphical depiction of a user interface to provide a review of inputted information and to receive input that directs submitting received information to generate the item information request, according to one embodiment.

FIG. 10 is a graphical depiction of a user interface presenting item information requests that have been received (or sent to) a business entity.

FIG. 11 is a graphical depiction of a user interface to present for review the general information and/or terms information of a received item information request, according to one embodiment.

FIG. 12 is a graphical depiction of a user interface to receive input specifying proposed pricing information for a response to an item information request, according to one embodiment.

FIG. 13 is a graphical depiction of a user interface to receive input specifying answers to questions of an item information request, for a response to the item information request, according to one embodiment.

FIG. 14 is a graphical depiction of a user interface to submit received input for a response to an item information request and/or to generate the item information request, according to one embodiment.

FIG. 15 is a graphical depiction of a user interface presenting responses to an item information request, according to one embodiment.

FIG. 16 is a system for requesting and communicating item information of a business entity, according to one embodiment.

FIG. 17 is a flow diagram of a method for requesting and communicating item information, according to one embodiment.

FIG. 18 is a flow diagram of a method for receiving and/or generating an item information request, according to one embodiment.

FIG. 19 is a flow diagram of a method for receiving and/or generating a response to an item information request, according to one embodiment.

### DETAILED DESCRIPTION OF PREFERRED EMBODIMENTS

Business entities consume a variety of products and services. Commodity-type goods and services are easy to locate and obtain. However, business entities sometimes seek specialty products and/or services. Locating suppliers of specialty products and/or services can be challenging and often is accomplished through a personal or professional relationship of an employee (e.g., a buyer).

The Internet, including the world wide web (www), and Internet search engines, such as Google and Yahoo, can facilitate identifying a supplier of a specialty product/service. Unfortunately, many suppliers of products/services are small businesses that lack time, skill, and/or resources to develop an adequate, let alone sophisticated, online presence. As a result, Internet searching may not lead to discovery of potential suppliers as desired (or to discovery of a desired number of options of suppliers from which to choose). Even if all suppliers were to have an Internet presence, Internet searches also do not enable straightforward identification and acquisition of product and/or service information, such as specifications and cost per unit information. An employee (e.g., a buyer) of a business that is seeking to obtain a particular product/service may be required to sift through pages of product/service information of one or more potential suppliers to glean desired product/service information. Alternatively, that employee could hunt for contact information and call or otherwise seek to contact the potential supplier. In either case, the process is time consuming and can be unfruitful.

Even when Internet searching is fruitful, often the available information does not include potential quantity discounts that may be offered for a large order or an extended term commitment of repeated purchases. The product/service information gleaned for multiple suppliers also is not easily comparable. Presently, the Internet does not facilitate searching business listings based on product/service type via a standardized categorization method or facilitate generating search results for multiple suppliers in an easily comparable format.

Internet directories seek to provide business listings and facilitate business searching. These directories are generally controlled by an administrator who decides what information is included in the directory. A supplier generally pays a fee for general contact information to be included in the directory. Such directories do not allow a business entity to control the look and feel of its listing within the directory. These directories also do not facilitate searching based on product/service type via a standardized categorization methodology. These directories also do not receive input regarding the product/service sought, such as quantities sought and desired specifications.

The Internet (including Internet directories) also does not presently facilitate efficient exchange of product/service information between business entities. Although a business entity seeking a desired product/service may find multiple suppliers through a search engine, discovering product-specific or service-specific information requires additional company-specific searching or requesting information from each of the multiple suppliers individually, such as via phone, email, website information request, etc. The responses to a request for information may be provided in a variety of ways. Some suppliers may call the requesting business entity, others may respond via return emails in a variety of formats, etc. If not all of the requested information is included, or if aspects of the response do not make sense, the requesting business entity must initiate another communication. This back-and-forth exchange is time consuming and inefficient.

Existing social networking implementations enable individuals to register and create profiles and then link with one or more other registered individuals by a defined relationship. These social networking implementations may facilitate communication with an established network. However, these social networking implementations generally do not facilitate business-to-business relationships, do not allow searching of business profiles based on product/service information, do not enable efficient exchange of product/service information, and do not enable comparison of product information received from multiple potential suppliers.

The present disclosure is directed to systems and methods for businesses to connect and exchange product/service information. The systems and methods may be implemented in a client-server model, such as a website. A website according to the present disclosure may be modeled after, or include some or even many features of, social networking sites, such as Facebook, LinkedIn, Google+, and others, and may not only enable businesses to connect with each other, but also enable efficient exchange of product/service information between businesses. The systems and methods may include creation of and/or accessing a networking database having a plurality of records corresponding to entities, including businesses and individuals, in which records of businesses may be linked by defined relationships to one or more records of other businesses and in which the records of registered individuals are linked by defined relationships to a record of a business and possibly one or more other individuals. The systems and methods may enable creation of entity records, including user profiles and business profiles. A business entity may be able to control much or even all of the content of its business profile. The business profile may allow a business to advertise itself and its products/services.

The business profiles may be associated as a social network. The business profiles may also be searchable based on a variety of criteria, including product/service type or category. A business entity seeking a particular product/service can easily identify multiple potential suppliers. Once potential suppliers are identified, the business entity is also enabled to efficiently exchange information with the identified potential suppliers.

The users of the system may have a profile and may be affiliated with a business entity. The users may have the ability to search for businesses by any of the information in the business profiles, for example by market, industry, product/service category, and geographic area. The website may also allow users to act as “requesters” and “responders.” A requester can create a request for product/service information from selected companies, may select multiple potential suppliers to submit a request for product/service information, and may identify the potential suppliers based on search results of the business profiles. A potential supplier receiving a request for product/service information may receive notification via the system of a pending request. A potential supplier can become a responder by responding to the request.

A responder can create a response to a request for product/service information. The response may include, for example, the following information: a proposed price per requested unit of measure, estimated revenue (calculated field of proposed price×requested quantity), answers to specific requester questions, shipping/travel cost details, and other relevant item information. The system may enable a responder to view a list of all pending requests and sort by name, date due, date created, business, and product/service category. A responder may also save a response (e.g., as a template) and also view a history of responses.

A requester can view status of all responses received for a request and analyze/filter/sort responses, for example, by price, shipping, name, favorites, business rating, etc. A requester may also be able to mark favorites, request changes, approve/deny responses, and send a message/question to a responder that provided a given response. A requester's approval or denial of a response may result in an automatic notification sent to the responder that provided the response to notify the responder of the approval or denial. A requester can also save a request (e.g., as a template) and view a history of requests.

The system may allow businesses to connect with other businesses via connection requests, to form a social network. For example, an administrator of a profile of a first business may be enabled to generate a business connection request that may be sent to an administrator of a profile of a second business. The administrator of the second business may accept the request and thereby link the businesses. As another example, a user (e.g., a buyer) affiliated with a first business may request a connection to a second user (e.g., a regional representative) of a second business.

In the description that follows, the term “item” is used to refer to products and/or services that are provided by a supplier.

The subject matter disclosed may be described herein in terms of various functional components and processing steps. It should be appreciated that such components and steps may be implemented as any number of hardware or software components or combination thereof configured to perform the specified functions. For example, an exemplary embodiment may employ various graphical user interfaces, software components, and database functionality.

For the sake of brevity, conventional techniques for computing, data entry, data storage, networking, speech recognition, and/or the like may not be described in detail herein. Furthermore, the connecting lines shown in various figures contained herein are intended to represent exemplary functional relationships and/or communicative, logical, and/or physical couplings between various elements. As will be appreciated, however, many alternative or additional functional relationships or physical connections may be present in a practical implementation of a document creation and management system or method.

Business Profiles

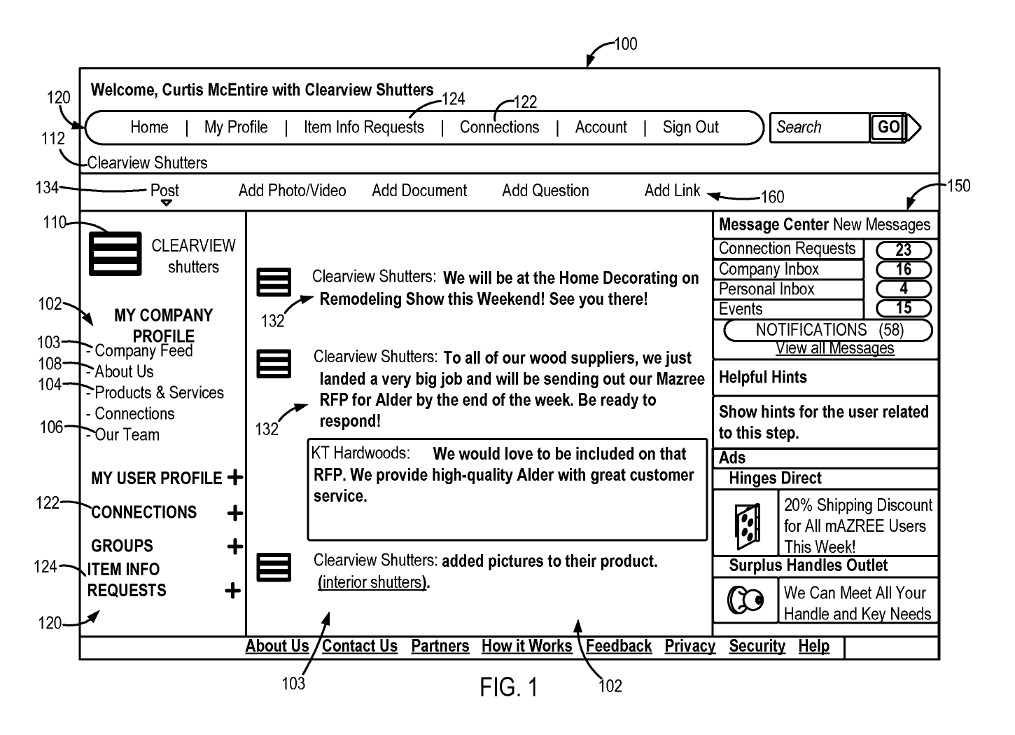

FIG. 1 is a graphical depiction of a user interface 100 displaying a business profile 102, or at least a portion thereof, according to one embodiment. A business profile 102 may include various information about a business. The business profiles 102 may be arranged and/or associated together via user initiated connections, such as in a social network. The business profile 102 may include a feed 103 that presents various posts 132 to the business profile 102, as presently displayed in the embodiment of FIG. 1. A post option 134 may enable a user to provide a post 132 on a business profile 102. The posts 132 may be posted by an administrator of the business profile 102, on behalf of the company, or by other users.

The business profile 102 may also include a listing of products/services (i.e., items) 104 and/or categories of items offered. The listing of items 104 and/or categories may be organized within the profile using a consistent taxonomy to enable easy and efficient filtering and searching. For example, the United Nations Standard Products and Services Code® (UNSPSC®) taxonomy may be used. Other potential taxonomies may include the North American Industry Classification System (NAICS), the North American Product Classification System (NAPCS), Global Industry Classification Standard (GIGS), Industry Classification Benchmark (ICB), among others.

The business profile 102 may also include a listing of the company team 106 (e.g., users affiliated with the business or users that work at the business). The individuals in the company team 106 may be sorted by geographic market in which they work, area of expertise, department, etc., as specified, for example, by a business profile administrator.

The business profile 102 may have multiple users and/or administrators with different levels of control. Administrators can make any changes to the profile (including deletion). Other users (with customizable control by an administrator) may be affiliated with the business and may have the ability to connect to other businesses, send messages, post information, send out proposal requests, respond to proposals, edit a personal profile, submit reviews, and receive business and or personal messages.

The business profile 102 may include information about the company, including a description of the business 108, a business logo 110, a business name 112, a slogan, and the like. The information about the company in the business profile 102, may include information such as a market description (e.g., worldwide, country, state, city), company size (e.g., 1-10 employees, 11-100 employees, 101-1,000 employees, 1,001-10,000 employees, etc.), business headquarters, office locations, general contact information, primary industry, and secondary industry.

Navigation options 120 may be provided on the user interface 100 to enable a user to navigate to other aspects of the business profile. The navigation options 120 may be provided in a bar along the top and/or a along one or more sides of the user interface 100. For example, a connections option 122 may allow a user and/or an administrator of a business profile to identify any business connections 122 to businesses that may already have profiles and/or to invite an existing business connection without a profile to join the system and create a business profile. A user can manually search for an existing business or person to request a connection. A user may also initiate a scan of contacts in a third-party system, such as Outlook, Gmail, Yahoo, or Hotmail contacts, to find contacts that may have a profile in the system. If any potential matches (contacts that have a user profile on the system) are identified, the user may be prompted and asked if he/she would like to send a connection request to the identified matches. For non-matches the user may be prompted with a question asking if they would like to send an invite to join the system by creating a profile.

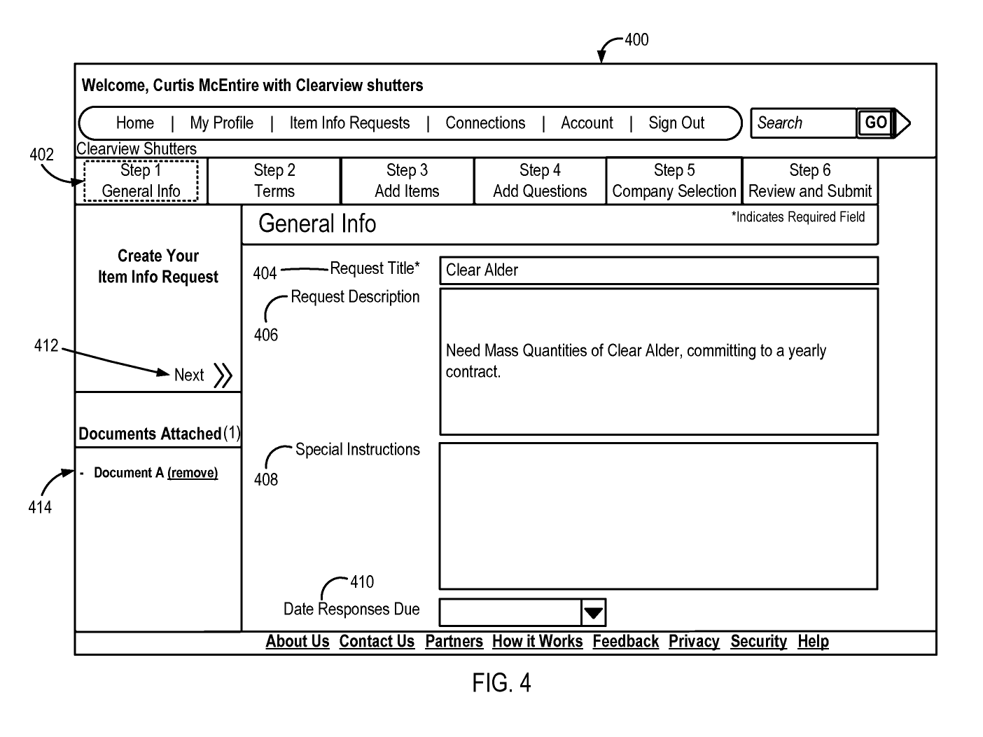

An item information requests option 124 may enable a user and/or administrator to view item information requests and/or create item information requests, as will be discussed more fully below with reference to FIGS. 4-9.

The user interface 100 may also provide a message center 150 that is associated with the business profile and presents messages/notifications received through the system. A summary of the received messages may be displayed by the message center 150. The message center may also be accessed to view the received messages. The messages/notifications may include connection requests, messages to the presently logged in user, messages to the user's company, event notifications, and the like.

Content options 160 may enable a user to add content to the feed 103 of the business profile. For example, the content options 160 may enable a user to add a photo or video, add a document, add a question, and add a link to the feed 103.

To create a business profile, information may be gathered about the business through one or more user interfaces. For example, a wizard may walk a user (e.g., a business administrator) through a series of questions, user interfaces, and/or steps, or the like to gather information about the business entity. The steps of the wizard, and information requested within those steps, may include, but are not limited to, requesting/receiving: company information 108, information about items 104 sold by the company, information regarding connections 122 of the business, and information regarding the company team 106. As can be appreciated, the information in the business profile may be modified and/or added after creation of a business profile. For example, input of company information may be sufficient for creation of a business profile. In another embodiment, input of a company name may be sufficient information to create a company profile.

The company information about the business entity requested and/or received may include: the business name 112, a brief description of the business 108, the year the business was founded, the business logo 110 (e.g., trademark), a business slogan, a description of the business's market (e.g., worldwide, country, state, city), a description of the company size (e.g., 1-10 employees, 11-100 employees, . . . 10,000+ employees), the location of the company headquarters (e.g., country, state, city), the other locations/offices of the business, general contact information for the business (e.g., phone, email, website, mail), a primary industry the business services, and a secondary business.

The system may facilitate automatic lookup of a business name 112 as letters are entered. For example, as a user (e.g., administrator for the business profile) begins entering keyboard characters, a business profile may be automatically searched to try to locate an existing business profile for the business entity. The system may also access external databases or information, for example via the Internet, to identify an appropriate business name 112. If a potential match is found the user interface may notify and ask the user if the suggested match is the same. If it is the same, subsequent steps of a business profile creation process may be bypassed.

Creation of a business profile may also include gathering of information regarding the company team. The information about the company team may include providing contact information for certain points of contact with the company (e.g., sales, accounting, marketing, etc.). The information may be gathered from user profiles of individuals affiliated with the company. The user profiles of connected individuals may be associated with the business profile of the company.

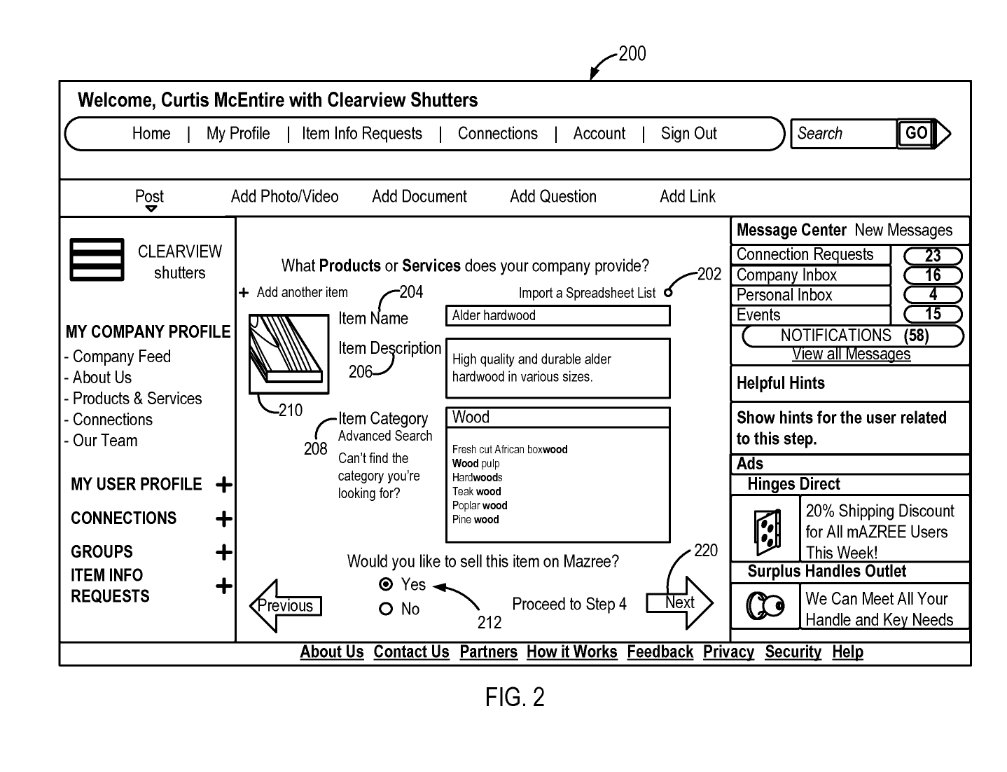

Creation of a business profile may also include gathering information about the items (e.g., products or services) that the company sells, as shown in FIG. 2 and described below with reference to the same. In another embodiment, the creation of the business profile may also include gathering information about the items that the company frequently buys, for example to identify to potential suppliers that the company is a potential customer for a particular item.

FIG. 2 is a graphical depiction of a user interface 200 receiving item information concerning an item of a business entity, according to one embodiment. The user interface 200 may present input fields to receive the item information. The input fields may be any of a variety of user interface components, including, but not limited to, text fields, text boxes, menus, drop down menus, drop-down selection boxes, lists, buttons, check boxes, and radio buttons. The item information requested and/or received through the input fields may include, but are not limited to, the item name 204, the item description 206, and the item category 208.

The categorization of an item (i.e., item category 208) may be driven by a defined taxonomy (e.g., The United Nations Standard Products and Services Code (UNSPSC), which is a hierarchical convention that is used to classify all products and services. See www.unspsc.org). The taxonomy may have differing levels of hierarchy. For example, UNSPSC has 5 levels of hierarchy (Segment, Family, Class, Commodity, and Business Function levels). However, administrators may need to add additional categories to fill in any potential gaps of the chosen classification system. When terms for an item category 208 begin to be entered (e.g., typed), suggested terms may be prompted and/or auto-completed. An advanced search may allow for items to be searched by drilling through the classification hierarchy. By clicking on a “Can't find the category you're looking for?” option, a user can request that a new category be created. If a level 1-3 category is selected, a prompt may be presented to inquire if the user would like to refine the item category 208 further. If yes, an additional search box may open with a scrolling list of refined categories the user can search within or choose from. The system may also allow users to add images/photos 210 to a general gallery or assign images/photos to a particular item.

The system may also provide users an option to import 202 input from, for example, a spreadsheet. An administrator may be able to import a listing of the items (e.g., a product or a service) sold by the business via a spreadsheet having appropriate fields and information. Users may be able to add as many items as desired. The system may prompt the user to assign to each item a category that was previously defined. The system may provide the ability to “Select All” items and assign a category to all selected items.

A “Next” navigation button 220 may be activated (e.g., clicked) to navigate to, or otherwise present, another user interface configured to request and/or receive information regarding the company team 106 (see FIG. 1), for example employees, to add to the business profile. Information regarding the company team 106 that may be requested and/or received may include a listing of the key employees, such as primary buyers and/or sellers, for the business and their associated responsibilities, including name, gender, contact information (e.g., email, phone), title, responsible geographic area (e.g., worldwide, country, state, city), associated product or service item (from list of items already provided).

The navigation button 220 may be activated (e.g., clicked) again to navigate to, or otherwise present, another user interface configured to allow, for example an administrator of the business profile to identify any business connections 122 to other businesses that may already have profiles and to invite any existing business connections (individuals or companies) to join the system (e.g., the network of businesses) by creating a profile. A user may manually search for an existing business profile or user profile to request a connection. A user may also initiate a scan of Outlook, Gmail, Yahoo, or Hotmail contacts to find contacts that may have a profile in the system. If any potential matches (contacts that have a system profile) are identified, the user may be prompted and asked if he/she would like to send a connection request to the identified matches. For non-matches the user may be prompted with a question asking if they would like to send an invite to join the system by creating a profile.

As can be appreciated, the user interface may provide a sell activation input field 212 to receive information regarding whether the business would like to sell, or simply notify others of an availability to purchase, one or more items via the system. A company may be able to sell items, for example, via any of three primary sales methods: a traditional method in which the business can list regular pricing options available to other businesses; a fire sale method, in which the business can hold a “fire sale” with special pricing for a limited quantity or a limited time; and an auction method, in which a business can offer items via an auction for a specified period of time with a “buy-it-now” pricing option. If the business administrator selects “yes,” the user interface may automatically expand and/or present an additional user interface to present an additional set of questions, for example, relating to a unit of measure, a list price, a system price (e.g., a special price for system users), a minimum order quantity (quantity needed to access the system price), a connections price (special pricing for connections of the business and/or user within the system, and shipping terms and options.

As can also be appreciated, a wizard may be utilized to guide gathering of information to create a user profile for an individual user. The wizard may guide a user through a series of one or more steps to gather information about the user. The process steps and information requests within those steps to gather user information may include, but are not limited to gathering the user's name (e.g., first name and last name), email address, gender, birthday, employer/company (selected from list of business profiles, or option to create new business profile), job title, responsible geographic area (e.g., worldwide, country, state, city), and the user's photo. The system may require that a user profile be associated with a business profile.

Users may be able to make and manage connections and group them in their own way. Users may send messages to and receive messages from other users and/or businesses, including notifications of item information requests, responses to item information requests (e.g., price proposals or other proposals), fire sales, and auctions. Users may customize (e.g., turn on/off or otherwise configure) the various notifications that they want to receive. Additionally, users may post activity to their profile (information, events, item updates/additions, etc.). That activity list may be available for view on their profile and in a single stream for their connections (or who they specify) to view, combined with the activity streams of their other connections. Users can also provide reviews of the business, based on certification of having done business with the business.

Business Searching Based on Item Category

The system may enable users to search for businesses by information in the business profile including, but not limited to, business name, business description, item information, employee names, locations, etc. This search functionality can be used to identify, for example, potential suppliers of a desired item. The search function can also be used to identify potential connections and to obtain information about a business. The search function can also be used to identify (find) users of the system. The search function will search business profiles, including the team and the connections, which may find user profiles that match the search terms. To search, a user can type in a keyword in the search box and press “enter” or click a search button. The results of the search may be shown on a search results page, sorted by most relevant based upon the keywords. The results may include, but are not limited to, business logo, business name.

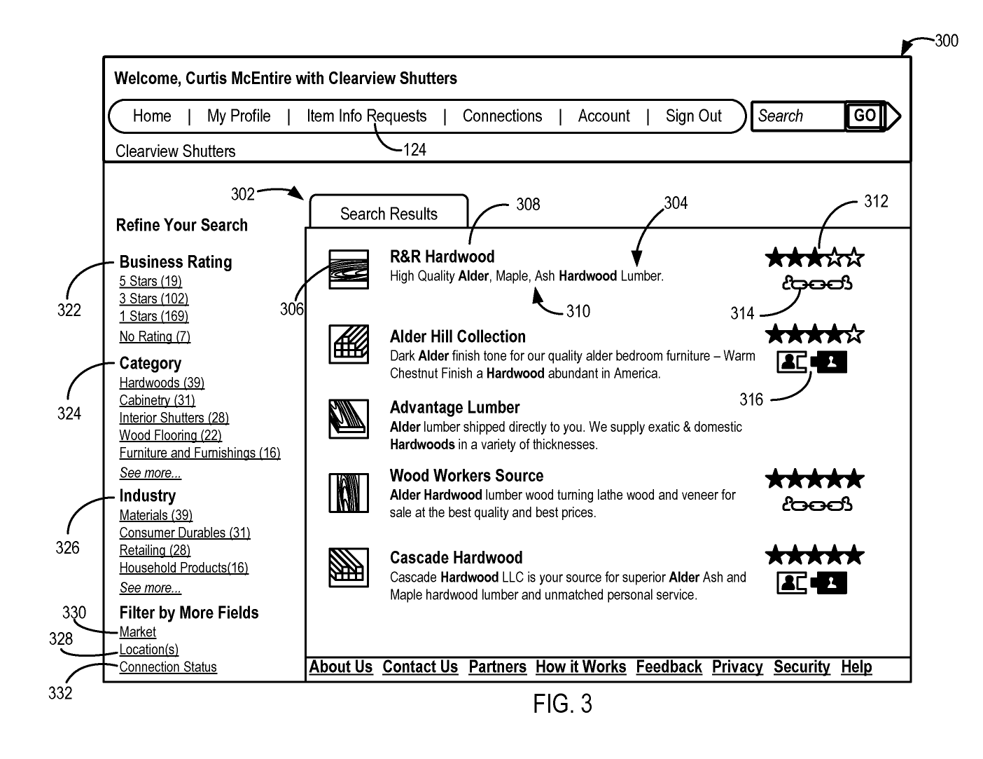

FIG. 3 is a graphical depiction of a user interface 300 displaying search results 302 of a search to identify request targets, according to one embodiment. The results may include information 304 about each identified business, for example a business logo 306, a business name 308, a summary 310 of relevant text, and a business rating 312. The summary 310 may include one or more lines of text from the business profile with the search keywords highlighted to illustrate the relevance of the business profile and also a basis for the business profile being included in the search results. A connection option 316 may be included in association with each business profile in the search results. If the user's company's business profile is already connected to a given business profile of another company, a connection indicator 314 may be provided to signal that there is already a connection in the system (e.g., an image of two entities “linked” together). If there is not a pre-existing connection, an invite option 316 may be provided to send a connection request by clicking on an image (e.g., image of two puzzle pieces connecting), link, or associated text. A “roll over” with the cursor, for example with a mouse input device, may present a description of the image representations.

A user may be able to select the business logo 306 or business name 308 to view that business's profile. A user may also select the rating 312 to view and read any ratings and reviews of that particular company that have been provided by users.

The system may enable searching based on, or enable a search to be refined and filtered based on, a variety of attributes, including but not limited to: a business rating 322, an item category 324, an industry 326 (primary industry or secondary industry as provided in the business profile), location(s) 328 of the business, a market 330, connection status 332, and company headquarters. The business rating 322 may be an aggregation of user ratings, based on transactions or other interaction or experience with the business. For example, users may rate the business on a scale of zero to five stars, zero being the lowest rating and five being the highest rating. A user may search for businesses based on business rating 322. Similarly, a search for businesses can be refined to present as results, for example, only businesses having a rating higher than a desired number of stars (e.g., three stars), in addition to matching other search criteria.

A search for businesses based on the item categories 324 connected to the business profile 102 may find all business profiles that include an item in the listing of items 104 that is categorized in a particular category. A business may appear in the results of a search based on any of multiple categories, depending on the other products and services that may be in their profile.

A search for businesses based on connection status 332 may allow a user to find businesses that the user and/or their company are connected with in the system. A search based on connection status 332 may also allow a user to find only businesses that the user and/or their company are not connected with.

As will be described, the search functions may be used to identify potential suppliers, or request targets, to which information requests may be sent by the requester.

Item Information Requests

The disclosed systems and methods may enable a user to request item information from a request target (or an administrator affiliated with a request target) and for another user affiliated with the request target (e.g., the administrator) to respond to that request. In other words, the system may enable users to act as requesters and/or responders. A requester can request item information from companies that the requester selects. As described more fully below, the requester may request information by creating an item information request. The requester can select multiple request targets to which to send an item information request. A request target may be a company that has indicated through a business profile that it sells, and therefore may be a potential supplier of, an item in the item information request. The requester may identify the request targets based on search results of a search of the business profiles in the system. An item information request may include, but is not limited to, the following information: request name, create date, requester name, business name, request type, item sought, item category and/or an item type, item name, item description, item specification, projected annual quantity, committed annual quantity. As can be appreciated, in another embodiment, the requester may be able to include a pricing proposal in a request, thereby inviting potential suppliers to agree to a pricing structure.

A business receiving an item information request (e.g., a request target) can act as a responder and can respond by creating a response to the item information request. A request target receiving an item information request may receive a notification of the receipt of the item information request so that a user affiliated with the business can act as a responder and create a response to the item information request. The response to the item information request may include, but is not limited to, the following information: proposed price per requested unit of measure, estimated revenue/estimated cost (calculated field of proposed price multiplied by requested quantity and presented according to perspective—i.e. estimated revenue for responder and estimated cost for requester), answers to specific requester questions, shipping/travel cost details, and other relevant item information. A request target may be enabled to view a list of all received item information requests that are pending a response from the responder and sort by name, date due, date created, business, and item category and/or item type. A responder (e.g., a request target that responds to an item information request) can also save item information requests, save responses to item information requests, and view a history of responses to item information requests.

A requester can view the status of all responses to an item information request that are received from responders and analyze/filter/sort the responses by price, shipping, name, favorites, business rating of responder, etc. The requester can mark favorites, request changes, approve responses, deny responses, and send a message/question to the responder. Requester approval or denial of a response may result in automatic notification to the responder. A requester can save bid requests and view a history of requests.

Item Information Request Creation

To create an item information request, a user may be guided through a series of steps, for example, by a wizard. To access the wizard, a user may click on an item information request option 124. A pop-up or other menu may appear with another option to “Create New” item information request.

An item information request may include general information, terms information, item detail information, and questions (directed to request targets). Generation of an item information request may also include designation of request targets that will receive the item information request. Collection of these various types of information may occur at one time (e.g., via a single user interface having various input fields) or may occur as a series of steps (e.g., through a plurality of user interfaces).

A user interface may be presented displaying an option for the user to start the new item information request from scratch or use a template for an item information request. A template may be useful, for example, when a user frequently generates item information requests having a set of information in common, such as common terms, common items, common questions, and/or common request targets. The template may pre-populate certain input fields or may allow the user to skip certain portions of input (e.g., information collection) when generating the new item information request.

FIG. 4 is a graphical depiction of a user interface 400 to receive general information for an item information request, according to one embodiment. The user interface 400 may present input fields to receive the general information. The input fields may be any of a variety of user interface components, including, but not limited to text fields, text boxes, menus, drop down menus, drop-down selection boxes, lists, buttons, check boxes, and radio buttons.

The user interface 400 may be one of several, for example in a wizard, that collect information to create an item information request. A status bar 402 may indicate progress in the collection of the information to generate the item information request. The status bar 402 presently shows that the process is at “Step 1 General Info,” to collect general information for the new item information request.

The general information requested and/or received through the input fields of the user interface 400 may include, but is not limited to, a request title 404 a request description 406, special instructions 408, and a date responses are due 410. In other embodiments, the general information may include a request create date (which may default to the current date). A document 414 may be attached to the item information request, allowing targets who receive the item information request to download the attached document, for example, to obtain additional information. A “Next” navigation button 412 (or other input component) may advance to display a next user interface, for example to collect terms information for the new item information request.

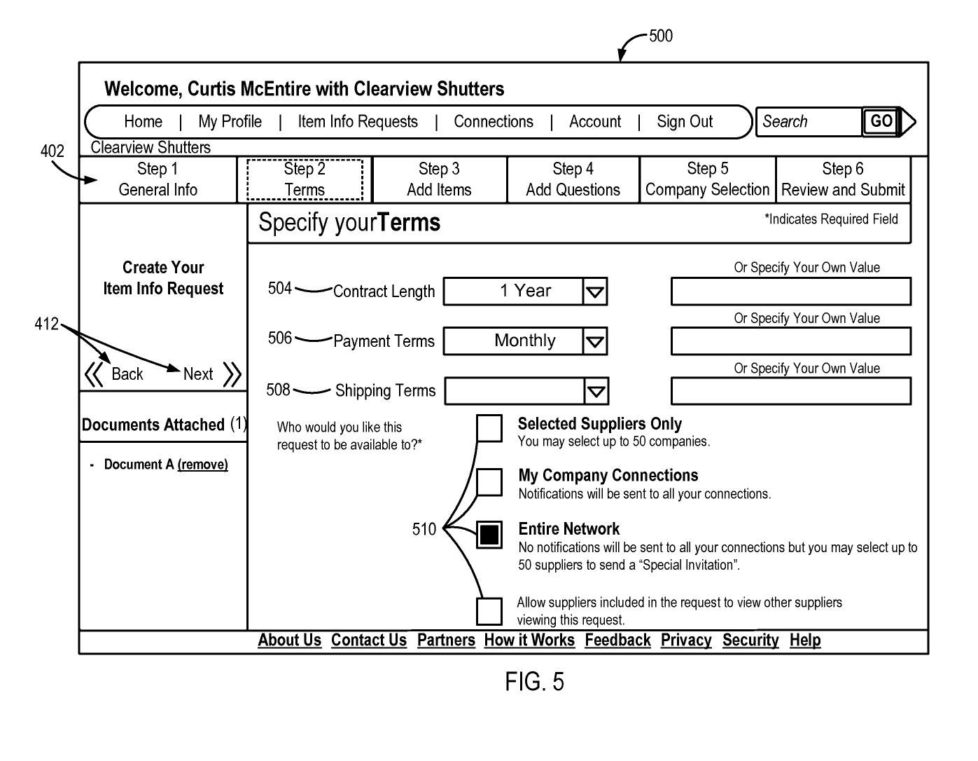

FIG. 5 is a graphical depiction of a user interface 500 to receive terms information specifying terms for an item information request, according to one embodiment. The status bar 402 in FIG. 5 indicates that the item information request process is at “Step 2 Terms” to collect term information for the new item information request. The user interface 500 may present input fields to receive the terms information. The terms information may be information about the terms on which the requester may be willing to enter into a purchasing/supplier contract. The terms may be of a degree of detail that a receiver of the terms (e.g., a request target/responder) may present an offer to sell the requested item(s) that may be agreeable to the requester. The terms information collected by the input fields of the user interface 500 may include a desired contract length 504, payment terms 506, shipping terms 508, target options 510 for designating to whom (i.e., which users and/or companies) the item information request will be made available. The target options may include “Selected Suppliers Only” (e.g., with a limit of, for example, fifty companies), “My Company Connections,” and the “Entire Network.” The terms information may be input using any of a variety of user interface components, including, but not limited to text fields, text boxes, menus, drop down menus, drop-down selection boxes, lists, buttons, check boxes, and radio buttons.

The “Next” navigation button 412 (or other input component) may advance to display a next user interface, for example to item detail information for the new item information request. A “Back” navigation button 412 (or other input component) may enable a user to go back to a previous user interface, such as user interface 400 to collect general information.

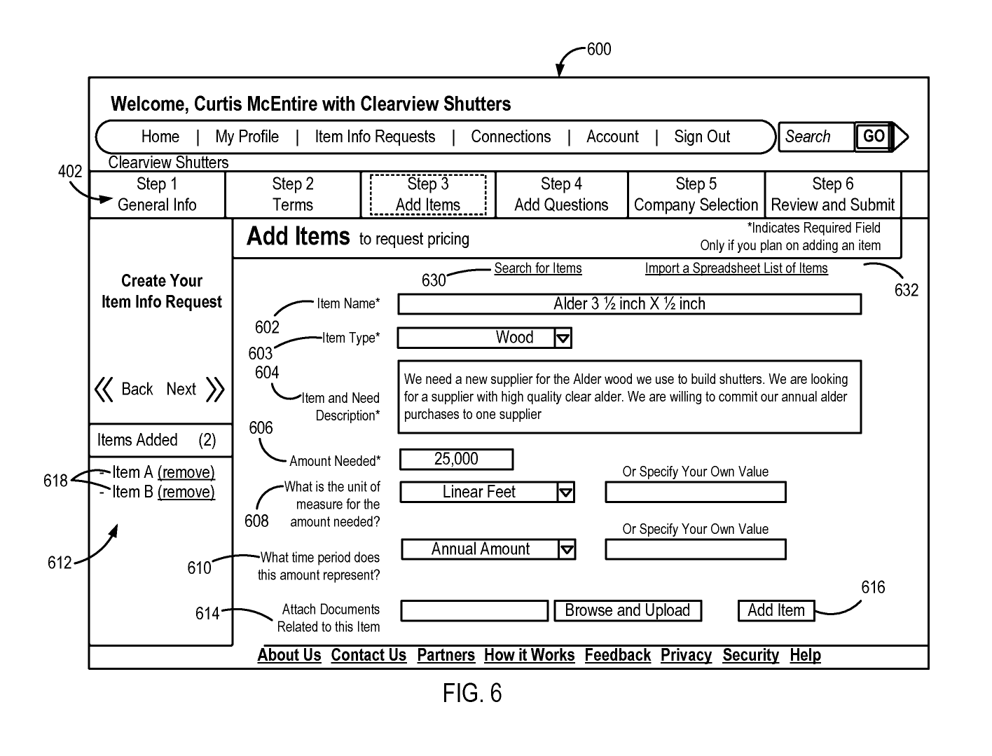

FIG. 6 is a graphical depiction of a user interface 600 to receive item detail information specifying item details for an item information request, according to one embodiment. The status bar 402 in FIG. 6 is advanced to “Step 3 Add Items.” The item detail information may designate one or more items 618 for which information is sought through the item information request presently being generated. The user interface 600 may present input fields to receive item details. The input fields may be any of a variety of user interface components, including, but not limited to text fields, text boxes, menus, drop down menus, drop-down selection boxes, lists, buttons, check boxes, and radio buttons. The item detail information requested and/or received through the input fields may include, but is not limited to, an item name 602 for an item (product or service) desired or for which information is being requested, an item type 603, an item specification 604, an amount needed 606, a unit of measure 608 for the amount needed, and a time period 610 for the amount needed.

The item type 603 may be a generalized categorization of the item being requested. The item types 603 may be pre-defined to provide a consistent, generalized categorization. For example, in the illustrated embodiment of FIG. 6, the item type 603 may be one of a product, software, equipment, and a service. In another embodiment the item type 603 definitions may be more specific. In still another embodiment the item type 603 may be replaced by or supplemented with an item category. An item category may be the same as, or at least correspond to, the item categories described above that are defined in a predefined taxonomy. For example, the item type 603, or alternatively the item category, may correspond to the UNSPSC® taxonomy, or any other taxonomy, including the other taxonomies disclosed above.

The item specification 604 may include details and/or required specifications (e.g., size, color, quality level, attachments, accessories, etc.) for an item that is the subject of the item detail information. The item specification 604 may also include some details about the reason for the request so that the request targets may have a better ability to provide more appropriate information. In certain circumstances, more details may make the request and response exchange easier and more effective.

The unit of measure 608 for the amount needed may specify the measurement of the amount of the item needed. For example, if 2,000 pairs of gloves are needed, then the unit of measure may be “Pair.” Moreover, if 4,000 lbs. of gravel are desired, then the unit of measure may be “Pounds.” The unit of measure 608 input field may include a drop-down of standard choices as well as a field to specify another unit of measure as desired by the user. The standard choices may include, but are not limited to, area (e.g., square inch, square foot, square yard, acre, square mile, square kilometer), unit (e.g., each, pair), length (e.g., inch, foot, meter, yard, mile, kilometer), liquid volume (e.g., cup, pint, quart, liter), volume (e.g., cubic inch, cubic foot, cubic yard, cubic meter), and weight (e.g., ounce, pound, ton).

The time period 610 for the amount needed may be a period during which the amount needed may be exhausted or after which the amount needed may need replenishing. The time period 610 may provide an indication of the requester's future commitment to purchase additional items. The time period 610 input field may have a drop-down of standard choices as well as a field to define a custom time period. The standard choices for the time period 610 input field may include: one-time purchase, weekly, monthly, quarterly, and annually.

In another embodiment, the item detail information (and/or input fields) may also include whether the item will require shipping and/or special shipping instructions. This input may provide insight or determine whether additional questions regarding shipping need to be asked. For example, if a user selects “Yes,” to indicate that shipping and/or special shipping instructions are applicable, the system may add follow-on questions for the request targets to answer in relation to this item. Examples of follow-on questions may include: “With what regularity will you need this item shipped?” (e.g., one time, weekly, semi-monthly, monthly, quarterly, semi-annually, annually), “Where would you like this item to be shipped?”, “How would you like the suppliers to include the cost of shipping?” (e.g., do not include, include it with the individual price of the item, include it as a lump sum for total amount needed for this item, include it as a lump sum for the total request (all items included)).

The user interface 600 may also provide an input field to attach or upload documents 614 that may be related to the one or more items that are the subject of the request.

An “add item” button 616 may be presented to enable a user to submit the item detail information and/or direct the system to add it as an item 618 of the item information request. As depicted in FIG. 6, an item information request may include one or more items 618. A listing of items 612 may show the items 618 added to the item information request that is being generated.

In another embodiment, the user interface 600 may present an input field to enable the requester to designate whether the requester is willing to commit to purchase the item of the item information request from a single supplier. A plurality of options may be presented, such as: not willing to commit, willing to commit a specified volume, willing to commit for a specified period of time.

An option to search for items 630 may be provided, to enable a requester to identify, for example, items 618 that may have been previously created in another item information request or templates of items 618 that may have been previously created, thereby relieving a user from entering item detail information of which the system may already be aware or have stored.

For an item information request that may include many items 618, a spreadsheet import option 632 may be provided to enable importing a spreadsheet of the items, thereby relieving a user from entering item detail information for multiple items 618 via the input fields of the user interface 600. The imported spreadsheet (or other file) may have as column headers the various aforementioned input fields for providing item information detail that may be defined in the system.

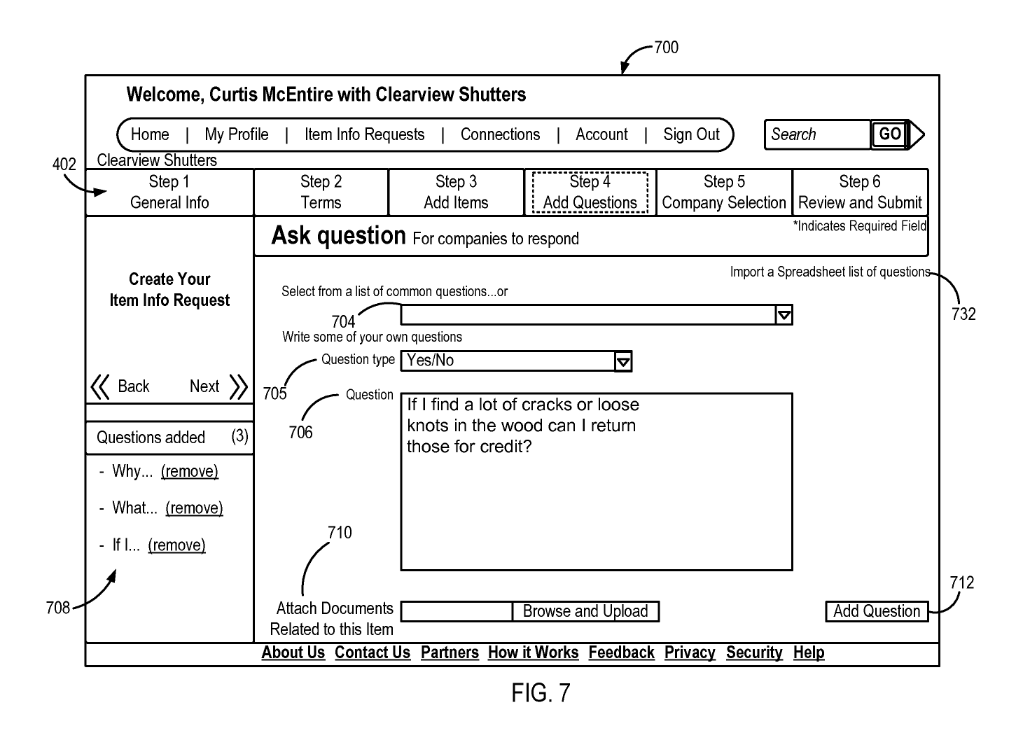

FIG. 7 is a graphical depiction of a user interface 700 to receive input specifying questions for an item information request, according to another embodiment. The status bar 402 in FIG. 7 is advanced to “Step 4 Add Questions.” The questions may be added (included), by a requester, in an item information request to gather additional information from responders that can be used in selecting a responder with which to transact business. A listing of questions 708 may be provided to present an indication of the questions, or number of questions, presently added to the item information request being created.

The user interface 700 may receive input designating questions to include with an item information request. The questions may be requester questions directed to the request targets, which a responder to the request may be required to answer to submit a response to the item information request. The questions may relate to specific items included in the item information request. Alternatively, or in addition, the questions may be more general and relevant, for example, to various items, the manner that the request target prefers to transact business, and the like. A common questions dropdown list 704 may be presented to allow selection of a question to add from a list of common questions. Examples of common questions from which a user may choose may include, but are not limited to the following:
What key attributes distinguish your organization from the competition?
What key attributes distinguish your product from the competition?
Why should I select your company?
Describe the financial condition of your company.
Please describe the specific grievance/resolution process for handling disputes from customers.
Please describe the help and training available with your product.
Describe the support services provided through your company's website, including forums and email.
Please describe your telephone support, and indicate hours of availability and fees, if appropriate.

A question field 706 may also be presented for a requester to use to write their own question to add to the request. A question type 705 may be designated (e.g., selected from a list of question types). The question types 705 may include, but are not limited to: Yes/No (e.g., the responder may be able to select either “Yes” or “No” to answer the question), choice (presenting the requester's generated list of possible answers from which the responder can choose), open-ended (allowing a responder to respond to the question with their own free-text answers), and date type (requiring the responder responding to the request to select a date as the answer to the question).

The user interface may provide an attach documents option 710 for attaching documents to the question, to thereby provide requests targets with additional information related to the question. An add question 712 input component may be provided that, when manipulate, adds the question from the input fields to the item information request.

For an item information request that may include many questions, a spreadsheet import option 732 may be provided to enable importing a spreadsheet of the questions, thereby relieving a user from entering item detail information for multiple questions. The imported spreadsheet (or other file) may have as column headers the various aforementioned input fields that may be defined in the system.

In some embodiments, an information request may comprise item detail information, without any questions. A requester may not have any questions to direct to the request targets. In some embodiments, an information request may comprise questions without any item detail information. A requester may wish to make inquiries (questions) directed to one or more request targets that may be more general in nature and not pertaining to a specific item need. The system may enable item information requests having merely questions, without item detail information, to be generated, communicated, stored, processed, tracked, and the like, similar to item information requests that include item detail information.

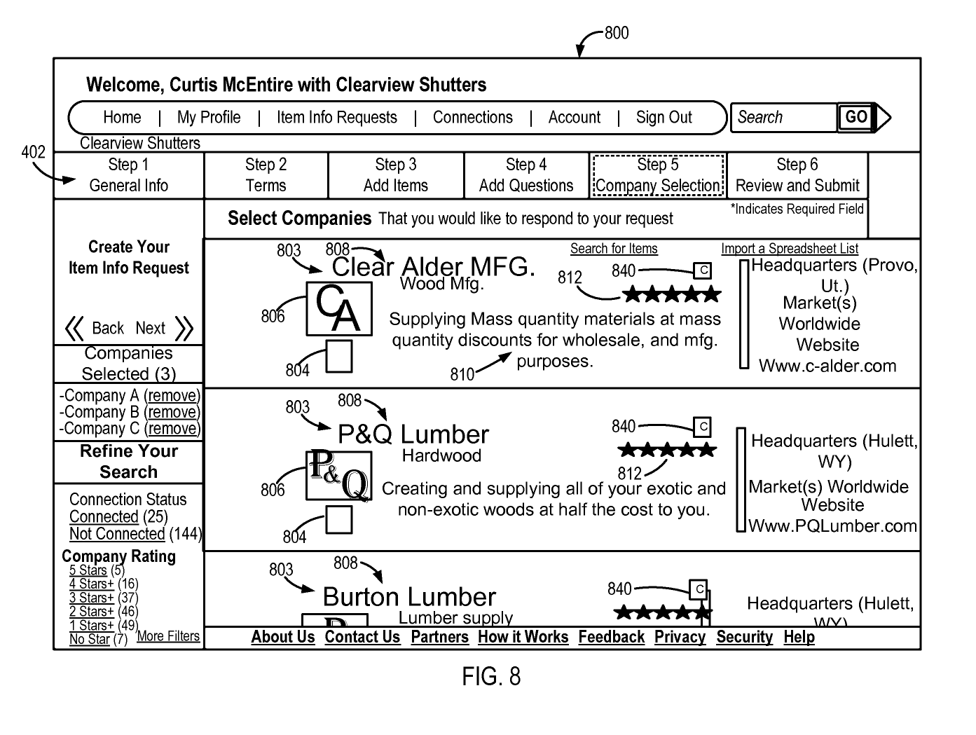

FIG. 8 is a graphical depiction of a user interface 800 to receive input containing information that specifies one or more request targets (e.g. companies) from which a requester desires pricing information for an item or other information. The status bar 402 in FIG. 8 is advanced to “Step 5 Company Selection.” The request targets may be selected from search results providing a listing 802 of potential suppliers, for example that may be identified through a search of business profiles (see FIG. 3 and discussion of same above). The user may be enabled to select from any suppliers with business profiles on the system. A check box 804, or other input component, may be presented on the user interface 800 adjacent to a business listing 803 (e.g., adjacent the business's name 808 or business logo 806) to allow a user to select that business as a request target. To protect against misuse and “spamming,” a requester may be limited in the number of request targets that can be designated (e.g., less than twenty-five). A brief description of the company 810 may be provided for each business listed in the listing 802 of potential suppliers. A rating 812 may also be provided for each business listed in the listing 802 of potential suppliers. A connection input 840 may also allow a user to send a connection request (invite to connect) to a business listed in the listing 802 of potential suppliers.

In one embodiment, search results may automatically default to businesses in the user's connection list. However, the user may be able to expand the results to include the entire network of businesses. As described above with reference to FIG. 3, users may be able to search for businesses to specify as request targets by any of the information in a business profile including, but not limited to, business name, business description, items information, employee names, locations, etc.

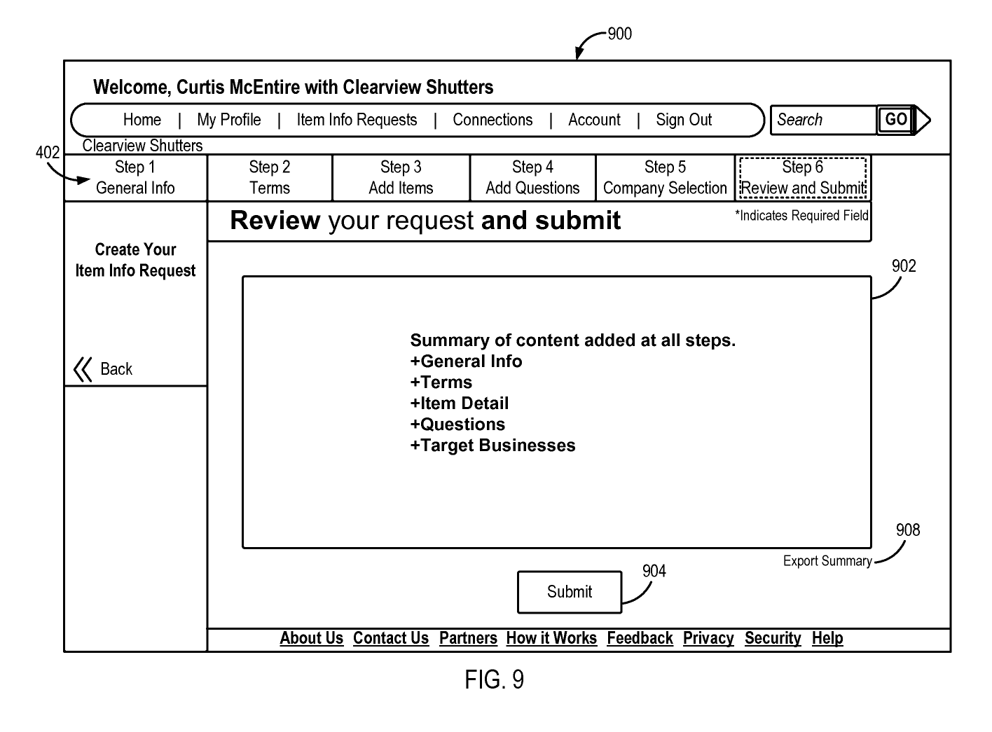

FIG. 9 is a graphical depiction of a user interface 900 to provide a review of inputted information and to receive input that directs submitting received information to generate the item information request, according to one embodiment. The status bar 402 in FIG. 9 is advanced to “Step 6 Review and Submit.” A summary 902 may be presented of all information received pertaining to an item information request. The summary 902 may summarize information received, for example, at multiple steps of an item information request generation process. The information may be grouped together according to steps at which the information was received. The summary 902 may present an option to edit sections of information (e.g., repeat information gathering steps individually). The summary 902 may also present an option to export the summary 908, for example, as a portable document format (.pdf) file, text file, or other file type.

A submit button 904, or other user interface component, may be provided that, when manipulated, submits all received input for processing and/or for generation of an item information request. A user may click the submit button 904, for example after reviewing the summary and verifying accuracy and completeness of the information being submitted.

In another embodiment, a legal disclaimer page may be displayed as part of a process to create/generate an item information request. For example, before beginning to collect information to create a request or a response to a request, the system may prompt the user to disclaim the system and its owners/operators of all liability regarding the item information request. Requesters and responders may be advised to do their own due diligence to determine which companies they choose to do business with. The legal disclaimer and other information may enable users to recognize that an exchange of item information using the system is not considered a creation of a contract or other binding agreement. Further, users may be advised to recognize that they may be permanently banned for unethical behavior on the system.

Receiving and Responding to an Item Information Request

When a request target is sent and/or receives an item information request from a requester, the system may notify the request target. A message may be communicated to a message center associated with the business profile of the request target. For example, a message may appear in a message center 150 (FIG. 1) that may be displayed on a home page and/or feed page when a user affiliated with the business entity is logged in. As another example, a business profile administrator may be presented with the message when accessing and/or viewing the business profile. The profile options may also allow for other forms of communicating a notification and/or message communication regarding a received item information request. For example, an administrator of a business profile may be able to configure notification preferences to receive text messages and e-mails when item information requests are received.

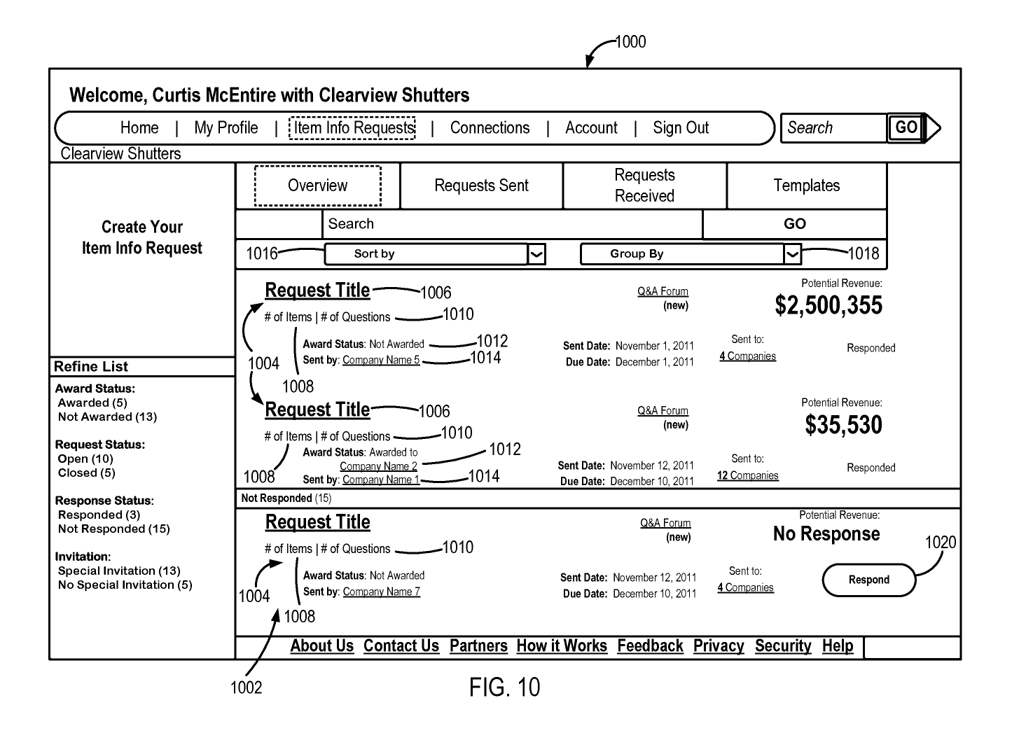

FIG. 10 is a graphical depiction of a user interface 1000 presenting item information requests that have been received by (or sent to) a business entity. When a user accesses his/her individual profile and/or a business profile of the business entity with which the user is affiliated in the system, the user can view a request overview page, which may present the user interface 1000 of FIG. 10. The user interface 1000 may provide a listing 1002 of item information requests 1004 received by the business entity that the user is affiliated with in the system. A brief summary of each received item information request 1002 may be presented, including the request title 1006, an indication of a number of items 1008 and/or a number of questions 1010, a status 1012 of an award of the requester of the item information request, and an indication of the name of the requester 1014 (the company from which the item information request was sent).

The user interface 1000 may provide sorting functionality 1016 to sort the received item information requests, for example by due date, requester name, request title, potential revenue, etc. The user interface may also provide grouping functionality 1018 to group (or filter) the received item information requests 1004 within the listing 1002 by connection status, number of items, number of questions, responded/no response, etc. The user interface 1000 may also provide a button 1020 or other input component to begin a response to an item information request 1004.

Similar to the process for generating an item information request, a process for generating a response to an item information request may be accomplished in one or more parts. For example, a wizard may walk a responder (e.g., a business administrator of a business entity) through a series of questions, user interfaces, steps, or the like to gather information from the responder. If the user selects (e.g., clicks on) one of the item information requests 1004 in the listing 1002, a request response tool may be launched.

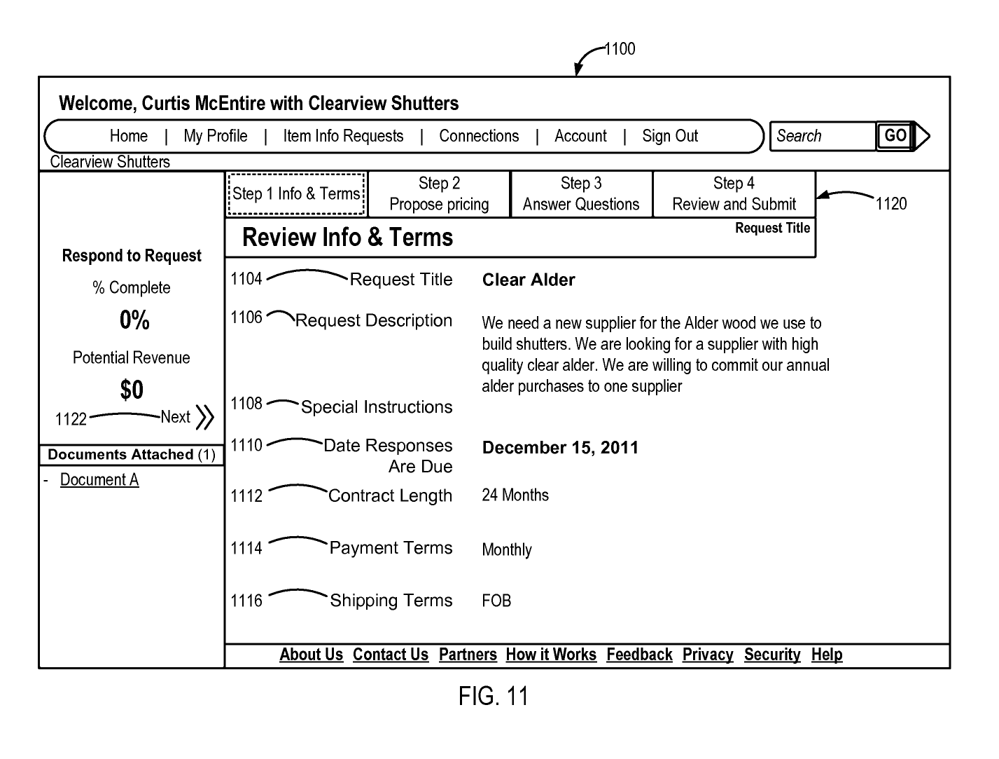

FIG. 11 is a graphical depiction of a user interface 1100 to present the general information and terms information of the item information request to enable a review of this information when responding to the received item information request, according to one embodiment. The user interface 1100 may be presented by a request response tool. The user interface 1100 may present the general information and terms information entered by the requester making the item information request. The general information and terms information provided by the requester, to generate the item information request, may be directed to a potential supplier (e.g., request target/responder) to inform the terms on which the requester may be willing to enter into a purchasing supply agreement. The user interface 1100 presents the general information and terms information in a manner to allow the responder to view and understand this general information and terms information.

The general information may include a request title 1104 a request description 1106, special instructions 1108, a date responses are due 1110. The term information may include a desired contract length 1112, payment terms 1114, and shipping terms 1116.

The user interface 1100 may merely present the information. Responder information may not be gathered by the user interface 1100. In another embodiment, an input may be provided to receive an acknowledgment, for example of review, of the general information and terms information.

The user interface 1100 may be one of several, for example in a wizard, that collect information to create a response to an item information request. A status bar 1120 may indicate progress in the collection of the information to generate the response to the item information request. The status bar 1120 shows that the process is at “Step 1 Info & Terms,” to review general information and terms information of the item information request, preparatory to providing pricing proposals for items in the item information request and/or answering questions in the item information request. Other steps of the wizard may include a step to propose pricing, a step to answer questions of the item information request, and a review and submission step. A “Next” navigation input component 1122 may advance to a display of a next user interface to collect terms information for the response to the item information request

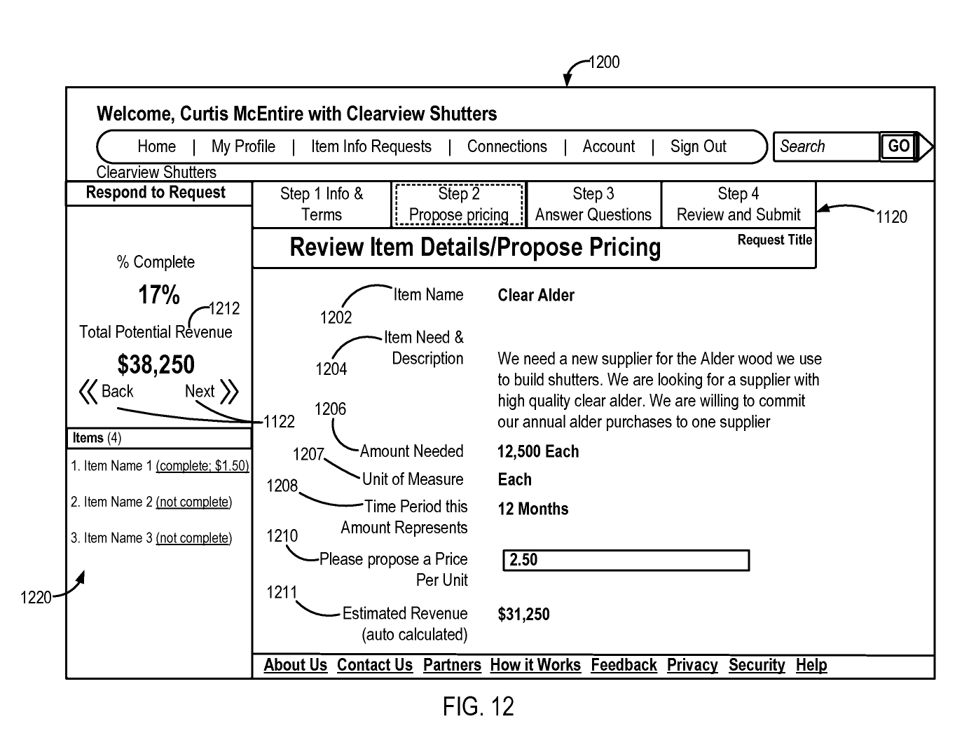

FIG. 12 is a graphical depiction of a user interface 1200 to receiving input specifying proposed pricing information for a response to an item information request, according to one embodiment. The status bar 1120 shows that the process is at “Step 2 Propose Pricing,” to collect pricing information for the response to the item information request. The user interface 1200 may present item details for one or more items included in an item information request. The item details may be information provided by the requester at creation of the item information request and may include but are not limited to an item name 1202, an item type (not shown), an item specification 1204, an amount needed 1206, a unit of measure 1207 for the amount needed, and a time period 1208 for the amount needed.

The user interface 1200 may also provide one or more input fields to receive proposed pricing information. The one or input fields may be any of a variety of user interface components, including, but not limited to text fields, text boxes, menus, drop down menus, drop-down selection boxes, lists, buttons, check boxes, and radio buttons. The input fields may include, but are not limited to a proposed price per the unit of measure 1210. A requester can enter proposed pricing information into the input field 1210 for inclusion in the response to the item information request.

The user interface 1200 may also provide an input field to provide an alternative unit of measure, to allow a responder to change the requested unit of measure, for example to match a unit of measure in which the responder typically provides the item. The user interface 1200 and/or system may automatically calculate to convert the amount needed 1206 and/or alternative unit of measure to the unit of measure 1207 of the requester, as provided and included in the item information request. The user interface 1200 may present the conversion, for example, to the side of the presentation of the amount needed 1206 and the unit of measure 1207 of the item information request.

The user interface 1200 and/or system may automatically calculate an estimated revenue 1211 from a sale of the amount needed at the responder's proposed pricing 1210. The estimated revenue 1211 may be presented for easy reference of the responder. Once a price proposal is entered into the input field 1210, the estimated revenue 1211 for that item may be automatically calculated and included in the estimated revenue field.

As noted above, the item information request may include a plurality of items. The user interface 1200 may present information relating to a single item at a time. All of the plurality of items may be provided in a listing of items 1220. Items for which proposed pricing has been completed may be marked as completed while items still outstanding may be marked as incomplete.

The user interface 1200 may also provide a total estimated revenue 1212. Once proposed pricing of an item is entered into the input field 1210, the total estimated revenue 1212 may update. The total estimated revenue may be determined by the sum of revenue 1211 for all items of the item information request for which proposed pricing has been provided. As can be appreciated, the revenue 1211 and total estimated revenue 1212 are included in the response to the information request and subsequently conveyed/presented to the requester, this information may be communicated as a “cost” and a “total estimated cost,” respectively.

The navigation inputs 1122 “Back” or “Next” may be manipulated to repeat previous portions or advance to other portions of gathering information for the response to the item information request.

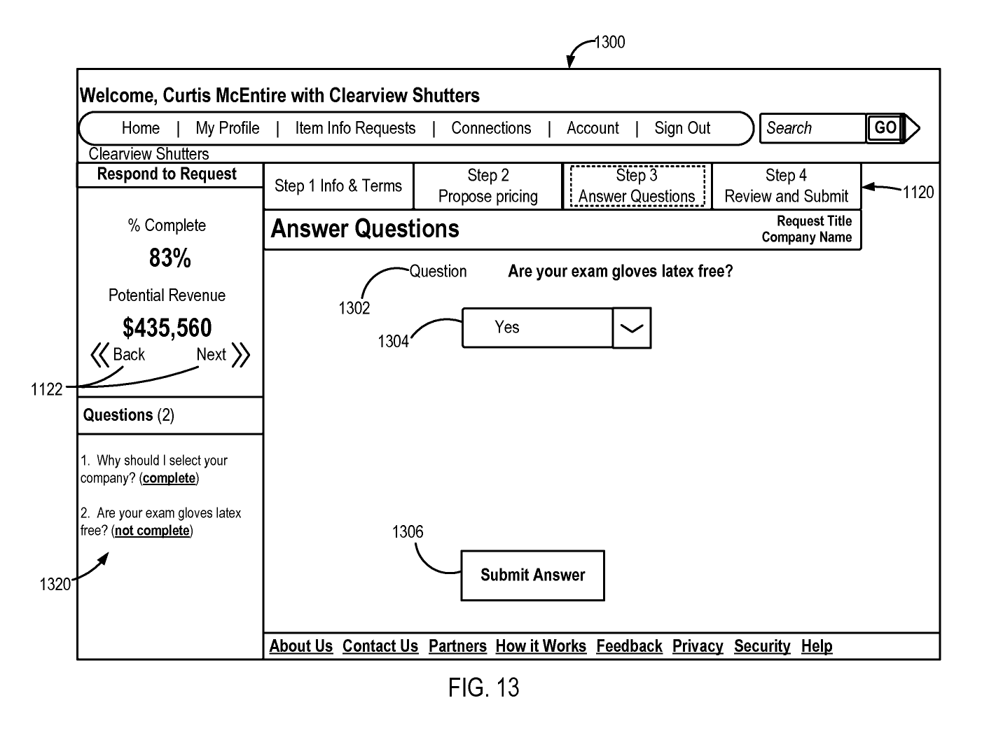

FIG. 13 is a graphical depiction of a user interface 1300 to receive input specifying answers to questions for a response to the item information request, according to one embodiment. The status bar 1120 presently shows that the process is at “Step 3 Answer Questions,” to collect answers to questions for the response to the item information request. The user interface 1300 may present one or more questions 1302 provided in the item information request. In the illustrated embodiment of FIG. 13, a single question is presented at a time. A listing of questions 1320 showing all the questions may be provided. Questions for which an answer has been provided may be marked as completed in the listing of questions 1320, while questions still outstanding may be marked as incomplete. In other embodiments, a plurality of questions may be presented at a time.

The user interface 1300 may also provide input fields to received answers. For example, a question may be presented with an answer input field 1304 adjacent to the question for providing an answer. The answer input field 1304 may be any of a variety of user interface components, including, but not limited to text fields, text boxes, menus, drop down menus, drop-down selection boxes, lists, buttons, check boxes, and radio buttons. The answer input field 1304 allows a user to input an answer to the question with information that may be specific to the responder.

A submit answer button 1306 may enable the user to submit an answer to a given question 1302 once the answer is provided in the answer input field 1304. The submit answer button 1306 may submit the answer and/or advance the process to a next question in the item information request.

The navigation inputs 1122 “Back” or “Next” may be manipulated to repeat previous portions or advance to other portions of gathering information for the response to the item information request.

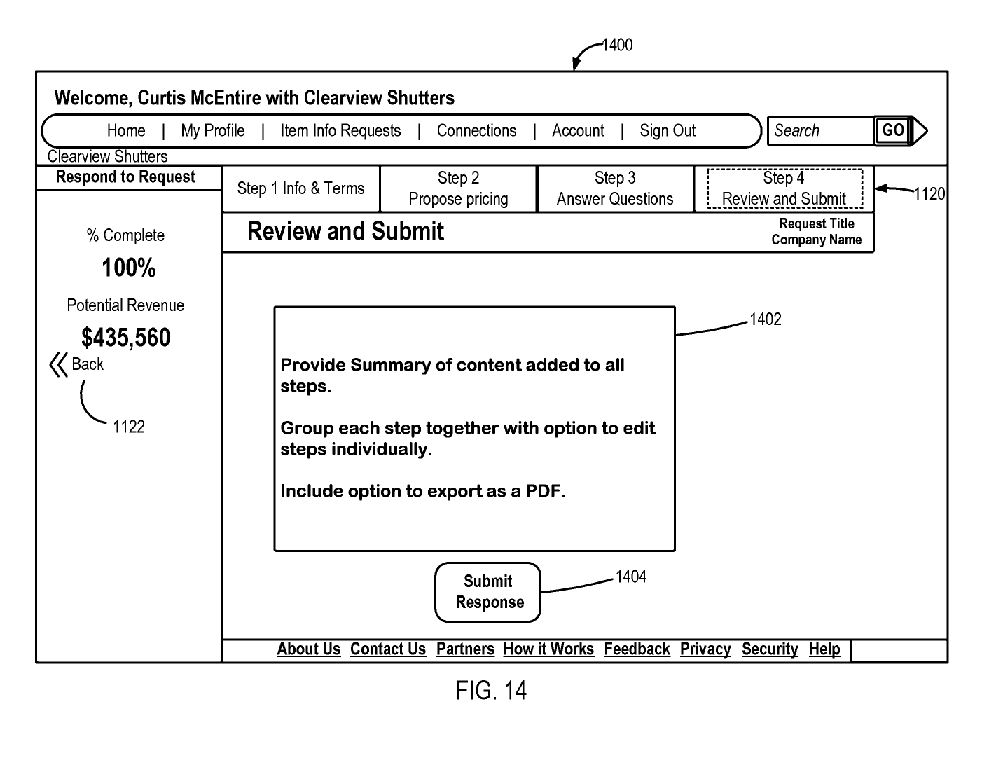

FIG. 14 is a graphical depiction of a user interface 1400 to submit received input for a response to an item information request and/or to generate the item information request, according to one embodiment. The status bar 1120 presently shows that the process is at “Step 4 Review and Submit,” to enable a user to review information of a response to an item information request and to submit the response, for example to the requester of the item information request. A summary 1402 of all information received pertaining to the response to the item information request may be presented. The summary 1402 may summarize information received, for example, at multiple steps of a process to generate a response to an item information request. The information may be grouped together according to steps at which the information was received. The summary 1402 may present an option to edit sections of information (e.g., repeat information gathering steps individually). The summary may also present an option to export the summary, for example, as a .pdf file, text file, or other file type.

A submit response button 1404, or other user interface component, may be provided that, when manipulated, submits all received input for processing and/or for generation of a response to the item information request. A user may click the submit button 1404, for example after reviewing the summary and verifying accuracy and completeness of the information being submitted.

A response to the item information request is then generated and communicated back to the requester. The response may be conveyed to a message center associated with the business profile of the requester. The response may also be communicated via another communications means, such as email, text message, and the like.

The “Back” navigation input 1122 may be manipulated to repeat previous portions of gathering information for the response to the item information request.

In another embodiment, a legal disclaimer page may be displayed as part of a process to create/generate a response to an item information request. For example, before beginning to collect information to create a response to an item information request, a prompt may be presented providing disclaiming language to disclaim the system and its owners/operators of all liability regarding the response to the item information request. Requesters and responders may be advised to do their own due diligence to determine which companies they choose to do business with. The legal disclaimer and other information may enable users to recognize that a response to an item information request using the system is not considered a creation of a contract or other binding agreement.

Receiving/Analyzing/Selecting Request Responses

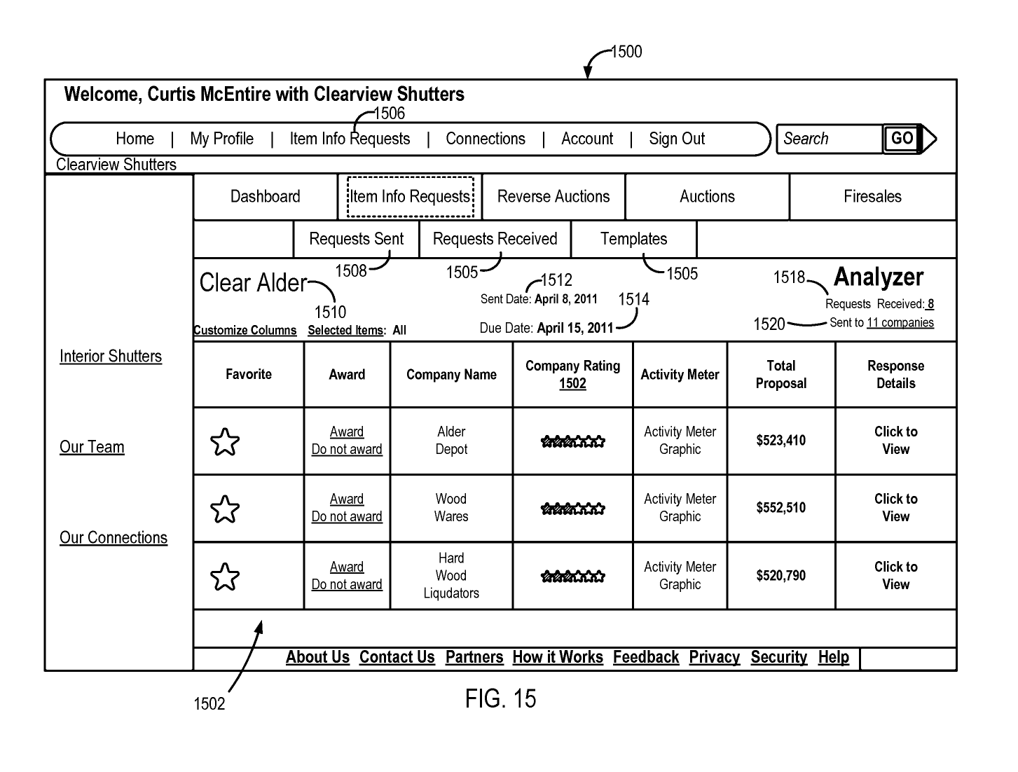

FIG. 15 is a graphical depiction of a user interface 1500 presenting item information requests 1501 and responses 1502 to item information requests, according to one embodiment. Any company with a business profile can be both a requester and a responder. Accordingly, the user interface 1500 enables a company to view requests sent 1508 (by the company as a requester), requests received 1506 (by the company as a request target), and templates for requests 1505. As request targets submit responses 1502 to an item information request, the requester may be able to view the received responses 1502 in real time on the user interface 1500.

The user interface 1500 may initially provide a listing of all item information requests of a requester. A user may have generated, for example, three different item information requests for the requester business entity. If the user selects a given request in the listing of all requests, the display of the selected request may automatically expand to show response summaries by supplier. The user may be able to sort its own item information requests by response due date, request create date, item type and/or item category, and request name. The user may also be able to view and filter item information requests by a “sent-to” supplier name, status, item type and/or item category, and request date.

Once the display of a selected item information request has been expanded, the user interface 1500 may provide high-level information regarding the selected item information request and display the received responses 1502. The high-level information may include, but is not limited to, the request title 1510, the request sent date 1512, the due date 1514 for responses to the request, the number of responses received 1518, and the number of companies that the item information request was sent to 1520. A response rate (e.g., a percentage of companies that have responded) may be provided. Also, an item category and/or item type may be provided in other embodiments of the user interface 1500.

As noted above, all the received responses 1502 for a selected item information request may be presented, for example as a listing. Because the responses 1502 are each generated in response to the same item information request, and utilizing a substantially similar process, the responses can be presented side-by-side for ease of comparison. For example, a response from a first business and a response from a second business may both include proposed pricing for an item that is based on the same amount and the same unit of measure. Viewing the responses side-by-side may enable quick and efficient comparison of the pricing proposals of the first and second businesses (potential suppliers / request targets). Accordingly, the requester can easily identify differences between the responses, including a total proposal price.

In the illustrated embodiment, the listing of responses 1502 provides high-level information, including a total proposal amount, and an option is provided to view response details.

The listing of responses 1502 may enable a user to mark favorites, award (e.g., approve) or deny responses, sort the listing, and filter the listing. The user can sort by favorites, company name, business rating, the total proposal, as well as any custom question where “free text” was not allowed (e.g., sort by responses to a “Yes/No” question). Additionally, the user can filter the results based upon responses to questions, rating, proposal, and favorites. The user can also narrow the view by selecting one of the items within the proposal to see the total proposal for just that item. The user may also be able to click on the proposal to view the details, such as line item pricing and responses to general questions. The user may also be able to customize the response view by adding or removing columns.

Once the user “Awards” or “Denies” responses, the approved and denied suppliers will automatically be notified and the request will be marked as “Closed.” The system may also present options for accepted responses. In one embodiment, the system may enable a user to accept a response and initiate a transaction. The requester accepts a proposal in a response from a responder and initiates purchase of the item (e.g., user may use a standard purchase agreement or upload their own agreement to be used). If the requester accepts a proposal and initiates a transaction, the system may automatically notify all other responders that they were not selected. The system may also allow a user to accept a response and initiate outside of the system whether a transaction will occur. Finally the system may allow a user to simply decide outside of the system, which allows the user to make their decision known to responders outside of the system. If a request due date is past 60 days and the request has not been closed by making a declaration using one of these options, the system may provide a prompt and ask the user if it can mark all proposals as a default status, such as “decided outside” of the system.

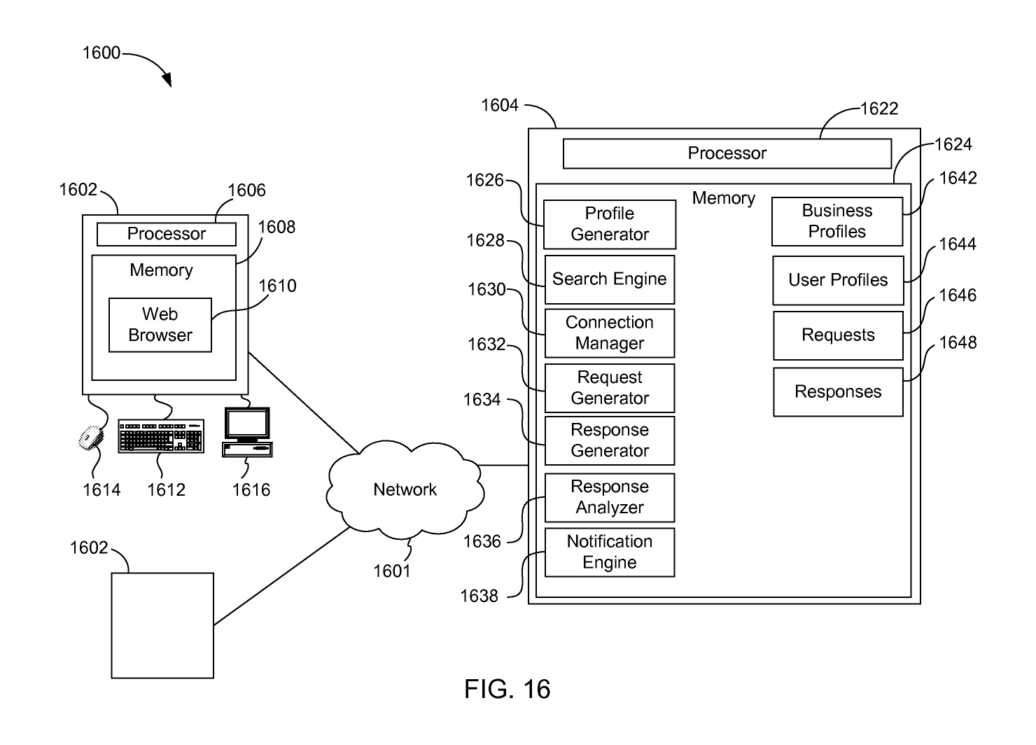

FIG. 16 is a system 1600 for requesting and communicating item information of a business entity, according to one embodiment. The system 1600 may include one or more clients 1602 and a server 1604. Each client 1602 may include a processor 1606, memory 1608, a web browser 1610, and one or more input devices, such as a keyboard 1612 and mouse 1614, and a display 1616 or other output device. The client 1602 may be coupled to the server via a network 1601, such as the World Wide Web or the Internet.

The server 1604 may include a processor 1622 and a memory 1624. Optionally, the server may include one or more input devices (not shown) and/or output devices (not shown). The system 1600 may further include a profile generator 1626, a search engine 1628, a connection manager 1630, a request generator 1632, a response generator 1634, a response analyzer 1636, a notification engine 1638, business profiles 1642, user profiles 1644, requests 1646, responses 1648, and a transaction engine.

As will be appreciated, the client 1602 and/or the server 1604 may be embodied in any suitable computing device, such as a personal computer, laptop computer, tablet computer, handheld device, or smart phone. Additional or alternative input devices may include but are not limited to a touch screen device, a microphone, a camera, and a digital pen. Moreover, the profile generator 1626, a search engine 1628, a connection manager 1630, a request generator 1632, a response generator 1634, a response analyzer 1636, a notification engine 1638, business profiles 1642, user profiles 1644, requests 1646, and responses 1648 may be distributed over any number of computing devices and/or between clients 1602 and servers 1604.

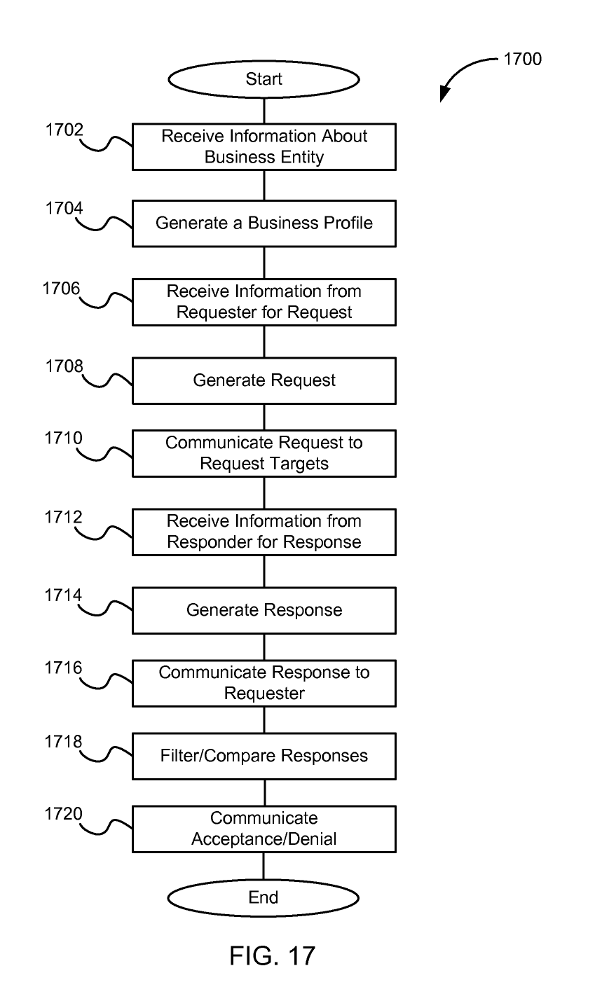

FIG. 17 is a flow diagram of a method 1700 for requesting and communicating item information, according to one embodiment. The method 1700 may include receiving 1702 information about one or more business entities (or companies). The method may include generating 1704 a business profile for each business entity based on the information received for that business entity. The business profiles may be associated via user initiated connections, for example into a social network. The method may include receiving 1706 information from a requester related to an item information request. The method may include generating 1708 an item information request. The item information request may be communicated 1710 to one or more request targets, for example through the social network. Information from a responder (one of the request targets) may be received 1712 and a response may be generated 1714 based on the information of the responder. The response may be communicated 1716 to the requester, for example, through the social network. The received responses may be filtered and/or presented 1718 for comparison. An acceptance or a denial of the responses may be communicated 1720 to each of the responders.

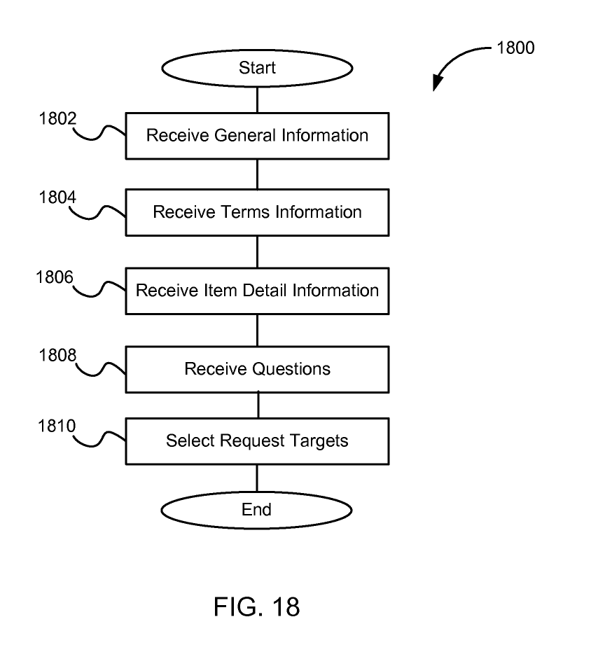

FIG. 18 is a flow diagram of a method 1800 for receiving and/or generating an item information request, according to one embodiment. The method 1800 may include receiving 1802 general information, receiving 1804 terms information, receiving 1806 item detail information, receiving 1808 questions that may be directed from the requester to one or more request targets, and selecting 1810 or otherwise designating one or more request targets to which the item information request is to be sent.

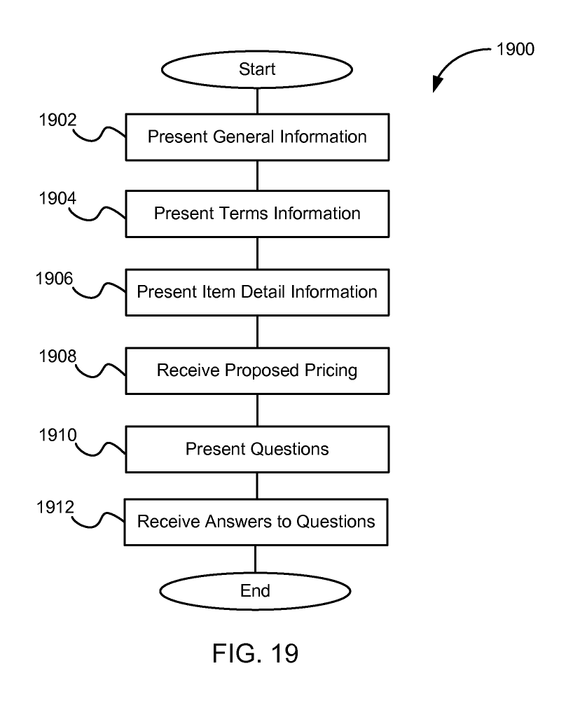

FIG. 19 is a flow diagram of a method 1900 for receiving and/or generating a response to an item information request, according to one embodiment. The method 1900 may include presenting 1902 general information from the item information request and/or presenting 1904 terms information from the item information request. The method may also include presenting item detail information 1906 for an item and receiving 1908 proposed pricing for the item. Questions may also be presented 1910 and responses to the questions gathered 1912.

This disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any suitable tangible, nontransitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including implementing means which implement the function specified. The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions specified.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The foregoing specification has been described with reference to various embodiments. However, one of ordinary skill in the art appreciates that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, system, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention.

What is claimed is:

1. A system for requesting and communicating item information of a business entity, comprising:
a processor;
a memory in communication with the processor;
a profile generator to receive information about a business entity, the profile generator using the information about the business entity to generate a business profile for the business entity, wherein the business profile is stored in the memory;
a request generator to receive information from a requester, the request generator using the information from the requester to generate an item information request and to send the generated item information request to one or more request targets, the information from the requester including a designation of one or more request targets, each request target of the one or more request targets having a business profile stored in the memory;
a response generator to receive information from a responder, the response generator using the information from the responder to generate a response to the generated item information request and send the response to the requester, wherein the responder is a given request target of the one or more request targets to which the generated item information request is sent, the response providing responder information that addresses the item information request; and
a notification engine to notify each request target of item information requests sent to that request target and to notify the requester of responses to the generated item information request.

2. The system of claim 1, wherein business profiles generated by the profile generator comprise:
a name of the business entity; and
item information for one or more items, including products or services, sold by the business entity, the item information including an item category associated with each item included in the business profile, the item category defined in a taxonomy that is consistently utilized to designate item categories of items in business profiles generated by the profile generator.

3. The system of claim 2, further comprising a search engine to search business profiles stored in the memory and identify business profiles that include items associated with a desired item category.

4. The system of claim 2, wherein business profiles generated by the profile generator further comprise:
one or more geographic locations of the business entity.

5. The system of claim 4, further comprising a search engine to search business profiles stored in the memory to identify business profiles that comprise a given geographic location of the business entity.

6. The system of claim 1, wherein the generated item information request comprises:
item detail information for one or more items for which the item information request is generated, the item detail information comprising an item name and an item type for each of the one or more items, wherein the item type is a pre-defined categorization that is utilized to designate item types for all item information requests generated by the request generator, wherein the item detail information for a corresponding item provides information to allow a responder to the item information request to determine pricing information for the corresponding item.

7. The system of claim 6, wherein the item detail information further comprises an item specification that describes a need for the corresponding item, the need being a need of the requester for the corresponding item.

8. The system of claim 7, wherein the item specification comprises at least one of an item size, an item color, an item quality level, and supplier type.

9. The system of claim 6, wherein the item detail information further comprises an amount needed indicating a quantity of the corresponding item that is needed.

10. The system of claim 9, wherein the item detail information further comprises a time period for the amount needed, wherein the time period provides an indication of a the requester's future commitment to purchase additional quantities of the corresponding item.

11. The system of claim 6, wherein the response to the generated item information request that is sent to the requester includes pricing information for at least on item of the one or more items for which the item information request is generated.

12. The system of claim 1, wherein the generated item information request comprises:
one or more questions of the requester directed to the request targets.

13. The system of claim 12, wherein the response to the generated item information request that is sent to the requester includes an answer to each of the one or more questions of the requester directed to the request targets by the item information request.

14. The system of claim 1, wherein the generated item information request comprises:
general information, including a request title for the item information request;
terms information, including a desired contract length, payment terms, and shipping terms.

15. The system of claim 1, wherein the profile generator is further configured to receive input providing user information that the profile generator uses to generate an individual profile that is stored in the memory, the user information including a business entity to which the individual is affiliated and that has a business profile stored in memory.

16. The system of claim 1, further comprising a network interface to couple the system to a network comprising a plurality of client computing devices, wherein the information from the requester is provided through input to a first client computing device and communicated from the first client computing device to the system over the network, and wherein the information from the responder is provided through input to a second client computing device and communicated from the second client computing device to the system over the network.

17. A computer-implemented method for facilitating exchange of item information between business entities, the method comprising:
receiving on a computing device information about a plurality of business entities;
generating a business profile for each of the plurality of business entities based on received information about each respective business entity and storing the business profile in a memory of the computing device;
receiving on the computing device information from a requester related to an item information request;
generating an item information request based on the information received from the requester, the item information request comprising:
a designation of one or more request targets to which an item information request is to be sent, each request target of the one or more request targets having a business profile stored in the memory; and
at least one of item detail information and questions, the item detail information about one or more items for which the item information request is being generated, the questions being inquiries of the requester directed to the one or more request targets;
sending the generated item information request to the one or more request targets;
receiving information from a responder that addresses the item information request;
generating a response to the information request based on the information received from the responder, the response comprising:
pricing information for at least one item of the one or more items, if the item information request comprises item detail information
answers to questions directed to the request targets, if the item information request comprises questions;
sending the response to the requester; and
communicating acceptance and denial of responses to each request target.

18. The method of claim 17, wherein sending the generated item information request to the one or more request targets comprises communicating a message to a message center associated with the business profile of a corresponding request target.

19. The method of claim 17, wherein sending the generated item information request to the one or more request targets comprises communicating a message to a message center associated with a user profile of a user affiliated with a corresponding request target.

20. The method of claim 17, wherein sending the response to the requester comprises communicating a message to a message center associated with the business profile of the requester.

21. The method of claim 17, further comprising presenting a plurality of responses to an item information request in a side-by-side fashion, with proposed pricing information included in each of the plurality of responses presented based on a same amount needed and unit of measure as specified in the item information request.
